(19) United States
(12) Patent Application Publication
(10) Pub. No.: US 2017/0336904 A1
(43) Pub. Date: Nov. 23, 2017

(54) CAPACITIVE POINTING STICK ASSEMBLY

(71) Applicant: SYNAPTICS INCORPORATED, San Jose, CA (US)

(72) Inventors: Lin-Hsiang HSIEH, Taipei (TW); Chao-Wei LIN, Taipei (TW)

(21) Appl. No.: 15/160,824

(22) Filed: May 20, 2016

(51) Int. Cl. G06F 3/041; G06F 3/044; G06F 3/033; G06F 3/0354

(52) U.S. Cl. CPC G06F 3/0416; G06F 3/0414; G06F 3/03547; G06F 3/044; G06F 3/033; G06F 3/0412; G06F 2203/04102; G06F 2203/04103

(57) ABSTRACT

An example isometric input device configured to control a user interface indicator of an electronic device includes a plurality of sensor electrodes disposed on a sensor substrate. The input device further includes a spring plate disposed between top and bottom spacers, the bottom spacer contacting the sensor substrate and defining a gap between the sensor electrodes and the spring plate. The input device further includes a control member mechanically coupled to the spring plate and a mounting plate in contact with the top spacer. The input device further includes a mounting bracket having an assembly of the mounting plate, the spring plate, the top and bottom spacers, and the sensor substrate mounted thereto.

### BACKGROUND

### Field of the Disclosure

Embodiments generally relate to input sensing and, in particular, to input sensing using capacitive pointing stick assembly.

### Description of the Related Art

Electronic devices, such as computers, can include or be connected to various input devices for interacting with a user. Example input devices include keyboards, pointing devices, proximity sensor devices (also commonly called touchpads or touch sensor devices), and the like. Both a pointing device and a touchpad can be used to provide input interfaces to the electronic device. For example, a pointing device and/or touchpad allow the user to move a cursor or other type of user interface indicator on a display. A “pointing stick” is one type of pointing device used, for example, with desktop and notebook computers. A pointing stick is a small analog joystick, usually disposed between the keys of a keyboard, which the user can manipulate to provide input to the electronic device. In some electronic devices (e.g., notebook computers), a pointing stick can be provided as an input option alongside a touchpad.

### SUMMARY

Embodiments generally provide an input device, a processing system, and method to control a user interface indicator of an electronic device. In an embodiment, an isometric input device configured to control a user interface indicator of an electronic device includes a plurality of sensor electrodes disposed on a sensor substrate. The input device further includes a spring plate disposed between top and bottom spacers, the bottom spacer contacting the sensor substrate and defining a gap between the sensor electrodes and the spring plate. The input device further includes a control member mechanically coupled to the spring plate and a mounting plate in contact with the top spacer. The input device further includes a mounting bracket having an assembly of the mounting plate, the spring plate, the top and bottom spacers, and the sensor substrate mounted thereto.

In another embodiment, a processing system for an input device configured to control a user interface indicator of an electronic device includes a sensor module and a determination module. The sensor module includes sensor circuitry, the sensor module configured to operate a plurality of sensor electrodes on a sensor substrate disposed proximate to a spring plate mechanically coupled to a control member by driving a sensing signal on a first subset of the plurality of electrodes and receiving resulting signals from a second subset of the plurality of electrodes, the resulting signals including effects from a change in spacing between the sensor substrate and spring plate caused by a deflection of the spring plate. The determination module configured to measure a change in capacitive coupling based on the resulting signals.

In another embodiment, a method of operating an input device configured to control a user interface indicator of an electronic device comprises operating a plurality of sensor electrodes on a sensor substrate disposed proximate to a spring plate mechanically coupled to a control member by driving a sensing signal on a first subset of the plurality of electrodes and receiving resulting signals from a second subset of the plurality of electrodes, the resulting signals including effects from a change in spacing between the sensor substrate and the spring plate caused by a deflection of the spring plate. The method further comprises measuring a change in capacitive coupling based on the resulting signals.

### BRIEF DESCRIPTION OF THE DRAWINGS

So that the manner in which the above recited features of embodiments can be understood in detail, a more particular description of embodiments, briefly summarized above, may be had by reference to embodiments, some of which are illustrated in the appended drawings. It is to be noted, however, that the appended drawings illustrate only typical embodiments and are therefore not to be considered limiting of scope, for other equally effective embodiments may be admitted.

FIG. 1 is a block diagram of a system that includes an input device according to an example implementation.

FIG. 2 is an exploded view of an input device in accordance with embodiments.

FIG. 3 is a cross-sectional side view of the input device in accordance with embodiments.

FIG. 4 is a plan view of a spring plate according to an embodiment.

FIG. 5 is a schematic view of a sensor substrate according to an embodiment.

FIG. 6 is a simplified cross-sectional side view of an input device where a force is applied to a control member.

FIG. 7 is a block diagram of an input device according to an example implementation.

FIG. 8 is a flow diagram depicting a method of operating an input device configured to control a user interface indicator of an electronic device according to an embodiment.

FIG. 9 is a simplified cross-sectional side view of an input device as mounted to a keyboard in an electronic device.

To facilitate understanding, identical reference numerals have been used, where possible, to designate identical elements that are common to the figures. It is contemplated that elements of one embodiment may be beneficially incorporated in other embodiments.

### DETAILED DESCRIPTION

The following detailed description is merely exemplary in nature and is not intended to limit the embodiments or the application and uses of such embodiments. Furthermore, there is no intention to be bound by any expressed or implied theory presented in the preceding technical field, background, brief summary or the following detailed description.

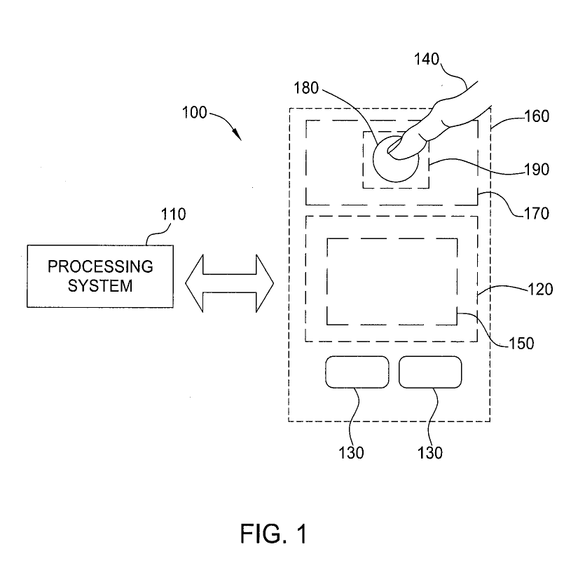

Turning now to the figures, FIG. 1 is a block diagram of an exemplary input device 100 in accordance with embodiments. In various embodiments, the input device 100 comprises one or more sensing devices, each of which can be integrated in, or coupled to, an electronic device 160. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice) and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system or can be physically separate from the electronic system. As appropriate, the input device 100 may communicate with parts of the electronic system using any one or more of the following: buses, networks, and other wired or wireless interconnections (including serial and or parallel connections). Examples include I²C, SPI, PS/2, Universal Serial Bus (USB), Bluetooth, RF, and IRDA.

In the embodiment depicted in FIG. 1, the input device 100 includes one or more input devices, such as a pointing stick 180 and a proximity sensor device 150 (also often referred to as a “touchpad” or a “touch sensor device”), each of which is configured to sense input provided by input object(s) 140 (illustratively shown as a user's finger). Proximity sensor device 150 is configured to sense input object(s) 140 in a sensing region 120. The pointing stick 180 is configured to sense input object(s) 140 in a sensing region 190. In an embodiment, the pointing stick 180 is disposed within or alongside another device 170, such as a keyboard (e.g., the pointing stick 180 can be disposed between keys of a keyboard). Alternatively, the pointing stick 180 can be a “stand-alone” device separate and apart from any other input device. In some embodiments, the proximity sensor device 150 can be integrated into a display device (not shown) (e.g., a touch screen). In other embodiments, the proximity sensor device 150 can be a stand-alone device (e.g., a touchpad). In some embodiments, the proximity sensor device 150 is omitted.

Sensing regions 120, 190 encompass any space above, around, in, and/or near the input device 100 in which the input device 100 is able to detect user input (e.g., user input provided by input object(s) 140). The sizes, shapes, and locations of particular sensing regions may vary widely from embodiment to embodiment. In some embodiments, the sensing regions 120, 190 extend from a surface of the input device 100 in one or more directions into space until signal-to-noise ratios prevent sufficiently accurate object detection. The distance to which the sensing regions 120, 190 extend in a particular direction, in various embodiments, may be on the order of less than a millimeter, millimeters, centimeters, or more, and may vary significantly with the type of sensing technology used and the accuracy desired. Thus, in some embodiments, the proximity sensor device 150 and the pointing stick 180 sense input that comprises no contact with any surfaces of the input device 100, contact with an input surface (e.g., a touch surface) of the input device 100, contact with an input surface of the input device 100 coupled with some amount of applied force or pressure, and/or a combination thereof.

The input device 100 may utilize any combination of sensor components and sensing technologies to detect user input in the sensing regions 120, 190. The input device 100 comprises one or more sensing elements for detecting user input. Cursors, menus, lists, items, and other user interface indicators may be displayed as part of a graphical user interface and may be scaled, positioned, selected scrolled, or moved in response to sensed user input.

In some capacitive implementations of the input device 100, voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitive sensing elements, such as sensor electrodes, to create electric fields. In some capacitive implementations, separate sensing elements may be ohmically shorted together to form larger sensor electrodes. Some capacitive implementations utilize resistive sheets (e.g., may comprise a resistive material such as ITO or the like), which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, changing the measured capacitive coupling. In one implementation, an absolute capacitance sensing method operates by modulating sensor electrodes with respect to a reference voltage (e.g., system ground) and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals and/or to one or more sources of environmental interference (e.g., other electromagnetic signals). Sensor electrodes may be dedicated transmitters or receivers, or sensor electrodes may be configured to both transmit and receive. Alternatively, the receiver electrodes may be modulated relative to ground.

In FIG. 1, a processing system 110 is shown as part of the input device 100. The processing system 110 is configured to operate the hardware of the input device 100 to detect input in the sensing regions 120, 190. The proximity sensor device 150 and the pointing stick 180 generally include an array of sensing elements. The processing system 110 comprises parts of, or all of, one or more integrated circuits (ICs) and/or other circuitry components. For example, a processing system for a mutual capacitance sensor device may comprise transmitter circuitry configured to transmit signals with transmitter sensor electrodes and/or receiver circuitry configured to receive signals with receiver sensor electrodes. In some embodiments, the processing system 110 also comprises electronically-readable instructions, such as firmware code, software code, and/or the like. In some embodiments, components of the processing system 110 are located together, such as near sensing element(s) of the input device 100. In other embodiments, components of processing system 110 are physically separate with one or more components close to sensing element(s) of input device 100 and one or more components elsewhere. For example, the input device 100 may be a peripheral coupled to a desktop computer, and the processing system 110 may include software configured to run on a central processing unit of the desktop computer and one or more ICs (perhaps with associated firmware) separate from the central processing unit. As another example, the input device 100 may be physically integrated in an electronic device, and the processing system 110 may comprise circuits and firmware that are part of a main processor of the electronic device (e.g., a notebook computer). In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing regions 120, 190 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates sensing element(s) of the input device 100 to produce electrical signals indicative of input (or lack of input) in the sensing regions 120, 190. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120 or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

It should be understood that while many embodiments are described in the context of a fully functioning apparatus, the mechanisms of the embodiments are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

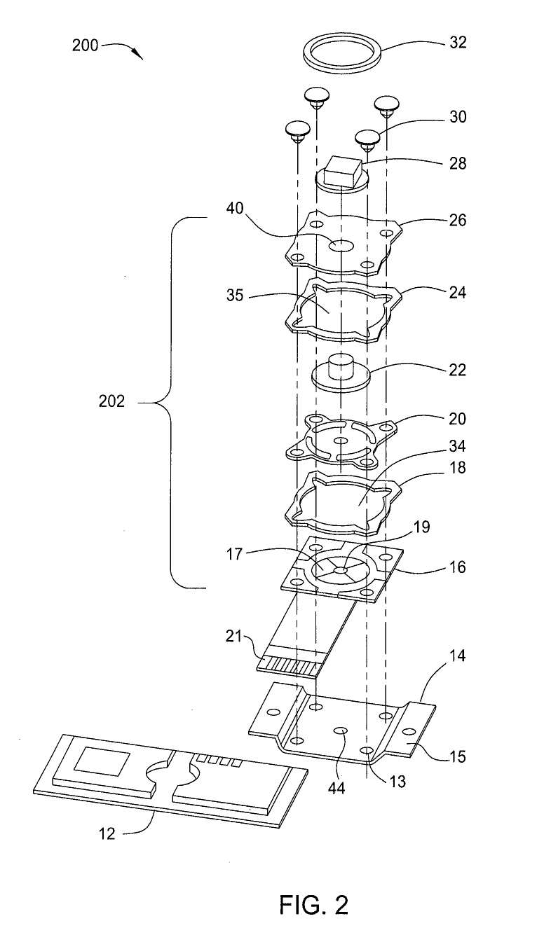

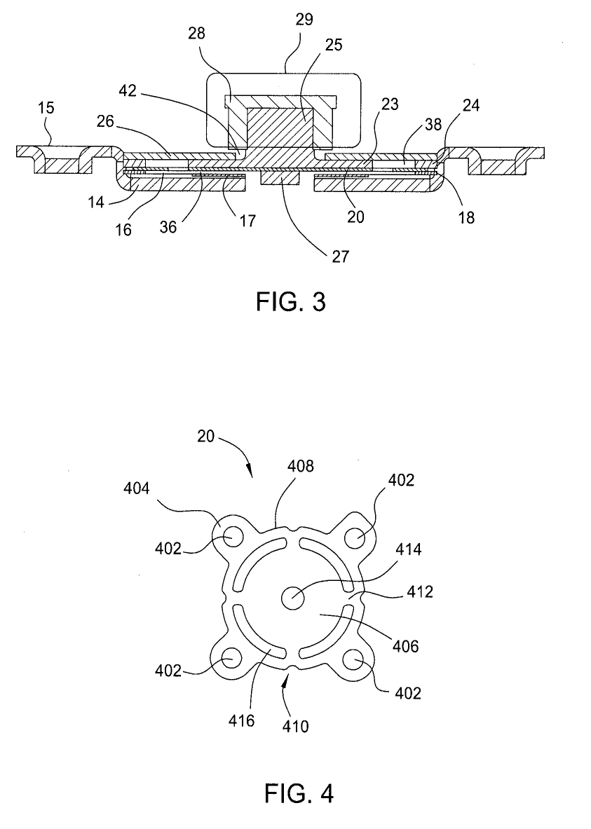

FIG. 2 is an exploded view of an input device 200 in accordance with embodiments. FIG. 3 is a cross-sectional side view of the input device 200 in accordance with embodiments. Some features shown in FIG. 2 are omitted from being shown in FIG. 3 for clarity. Likewise, some features shown in FIG. 3 are omitted from being shown in FIG. 2 for clarity.

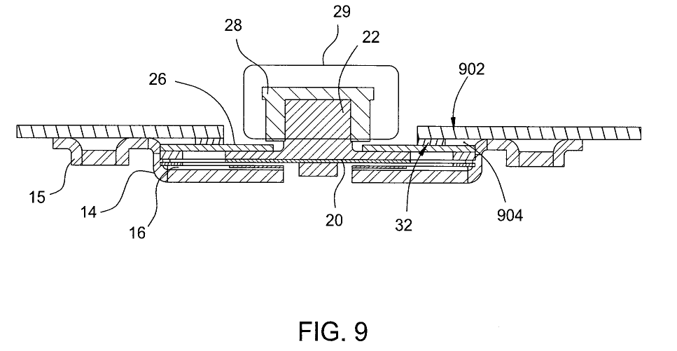

Referring to FIGS. 2-3, the input device 200 can be used as an embodiment of the pointing stick 180 shown in FIG. 1 to control a user interface indicator of an electronic device. The input device 200 includes a mounting bracket 14, a sensor substrate 16 (also referred to as a “flexible sensor substrate 16”), a spacer 18 (also referred to as a “bottom spacer 18”), a spring plate 20, a control member 22, a spacer 24 (also referred to as a “top spacer 24”), a plate 26 (also referred to as a “mounting plate 26”), an adapter 28, screws 30, and a sealing member 32. The mounting bracket 14 can be secured to or otherwise disposed proximate to a circuit board 12. The input device 200 can be disposed in an electronic device, such as a notebook computer. The sealing member 32 can be used to seal a gap between the input device 200 and a mounting area of the electronic device. An embodiment of the input device 200 mounted to a keyboard plate is shown in FIG. 9.

The plate 26, top spacer 24, spring plate 20, bottom spacer 18, and flexible sensor substrate 16 form a stack assembly 202 that is secured to the mounting bracket 14. Each of the plate 26, top spacer 24, spring plate 20, bottom spacer 18, and sensor substrate 16 include a plurality of mounting holes or slots. The plate 26, top spacer 24, spring plate 20, bottom spacer 18, and sensor substrate 16 are arranged in the stack assembly 202 so that the screws 30 can pass through the mounting holes/slots and engage with a plurality of threaded holes 13 of the mounting bracket 204. In the embodiment shown, the input device 200 includes four screws 30. In general, the input device 200 can include a plurality of screws 30. The mounting bracket 14 includes a flange 15 that can be secured to a structure of the device into which the input device 200 is mounted, such as a plate of a keyboard in a notebook computer. The mounting bracket 14 can be a single metal element machined into a desired shape for accommodating the stack assembly 202. The assembly 202 is mounted to the mounting bracket 14 so as to provide a conductive path between the mounting bracket 14 and the spring plate 20 (e.g., through screws 30). In this manner, a constant voltage (e.g., a reference voltage, such as electrical ground) can be applied to the spring plate 20 through the mounting bracket 14. That is, the spring plate 20 is ohmically coupled to a substantially constant electrical potential.

The sensor substrate 16 contacts the mounting bracket 14. The sensor electrodes 17 are insulated from the mounting bracket 14. The sensor substrate 16 includes sensor electrodes 17 disposed thereon. The sensor substrate 16 can include one or more conductive layers (not shown) separated by one or more dielectric layers (now shown). For example, the sensor substrate 16 can be a printed circuit board (PCB), flexible printed circuit (FPC), or the like. In the present example, the sensor substrate 16 has an annular shape having an aperture 19 in the center thereof. In other examples, the sensor substrate 16 can have a different shape generally having an aperture. The sensor electrodes 17 on the sensor substrate 16 can be coupled to conductive traces (not shown) on a connection medium 21, such as an FPC, ribbon cable, or the like, which can be used to drive signals to, and receive signals from, the sensor electrodes 17. The connection medium 21 communicatively couples the sensor electrodes 17 to the circuit board 12, which can include the processing system 110. In an embodiment, the processing system 110 is also coupled to a capacitive touch pad of the electronic device.

The control member 22 is mechanically coupled to the spring plate 20. In an embodiment, the control member 22 includes a base 23, a post 25 extending upward from the base 23, and a rivet 27 extending downward from the base 23. The base 23, the post 25, and the rivet 27 are cylindrical in shape. The rivet 27 extends through an aperture in the spring plate 20 (shown in FIG. 4) and secures the control member 22 to the spring plate 20. The mounting bracket 14 can include an aperture 44 having a circular shape. The rivet 27 can extend into the aperture 44. The diameter of the aperture 44 is such that the rivet 27 does not contact the mounting bracket 14.

The bottom surface of the base 23 contacts the top surface of the spring plate 20. In an embodiment, the control member 22 can comprise a single plastic element that is molded, printed, or the like using known techniques. In another embodiment, the control member 22 can comprise a single metal element (e.g., brass) that is machined into the base 23, the post 25, and the rivet 27 using known techniques. The adapter 28 fits over the post 25 of the control member. The adapter 28 can comprise, for example, a single plastic element that is molded, printed, or the like using known techniques. The adapter 28 can be secured to the post 25 of the control member 22 using an adhesive or through friction. A touch element 29 can be provided that fits over the adapter 28. The touch element 29 can be an elastomer or the like. The touch element 29 and/or adapter 28 provide a dielectric element that insulates a user's finger from the control member 22.

The bottom spacer 18 includes an aperture 34. The bottom spacer 18 is generally rectangular and the aperture 34 is generally circular. The bottom spacer 18 can be a single metal element having a desired thickness for separating the spring plate 20 from the sensor substrate 16. The bottom spacer 18 contacts the sensor substrate 16 and the spring plate 20.

The top spacer 24 includes an aperture 35. The top spacer 24 is generally rectangular and the aperture 35 is generally circular. The top spacer 24 can be a single metal element having a desired thickness for separating the spring plate 20 from the plate 26. The top spacer 24 contacts the spring plate 20 and the plate 26.

The control member 22 is disposed within the apertures 34, 35. As such, the spring plate 20 is suspended between the top spacer 24 and the bottom spacer 18. A gap 36 is formed between the spring plate 20 and the sensor substrate 16. An annular gap 38 is formed between the spring plate 20 and the plate 26. The top spacer 24 can have the same or substantially the same thickness as the base 23 of the control member 22 such that the plate 26 contacts both the top spacer 24 and the base 23. The plate 26 includes an aperture 40. The post 25 of the control member 22 extends upward through the aperture 40 of the plate 26. The aperture 40 is circular and incudes a diameter larger than the diameter of the post 25. As such, there is an annular gap 42 between the post 25 and the plate 26.

FIG. 4 is a plan view of the spring plate 20 according to an embodiment. The spring plate 20 includes a center disc 406 disposed within a ring 408. The center disc 406 is integral with the ring 408 through a plurality of ribs 412 (e.g., four ribs 412 are shown in the example). The center disc 406 is separated from the ring 408 between the ribs 412 forming slots 416. The center disc 406 includes an aperture 414. The rivet 27 extends through the aperture 414 and secures the control member 22 to the spring plate 20. In an embodiment, the diameter of the center disc 406 is the same as or substantially the same as the diameter of the base 23 of the control member 22. The ring 408 includes a plurality of ears 404 (e.g., four ears 404 are shown). Each of the ears 404 includes an aperture 402 for accommodating the screws 30. The ring 408 further includes notches 410 aligned with the ribs 412. The notches 410 assist the cantilever frame structure of the spring plate 20, causing the spring plate 20 to be more flexible and to allow for a stable and repeatable mechanism of movement during operation. In an embodiment, the spring plate 20 is a single metal element machined to form the elements described above and shown in FIG. 4.

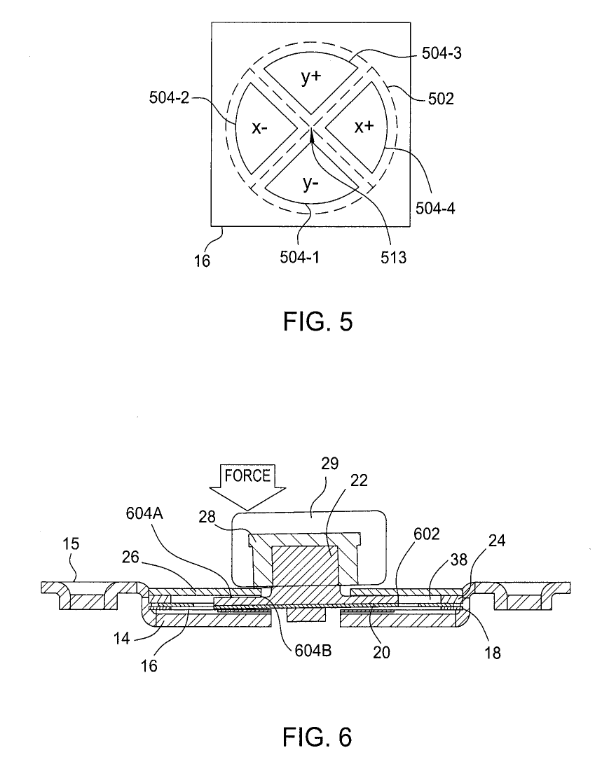

FIG. 5 is a schematic view of the sensor substrate 16 according to an embodiment. The sensor substrate 16 includes a sensor electrode area 502 forming a sensing region for the input device 200. The sensor electrode area 502 can be divided into quadrants designated y−, x−, y+, and x+. The sensor electrodes 17 are disposed on the substrate 16 such that unique sensor electrode patterns 504-1, 504-2, 504-3, and 504-4 are disposed in the quadrants y−, x−, y+, and x+. A center 513 of the sensor electrode area 502 is substantially aligned with a center of the aperture 19 in the substrate 16.

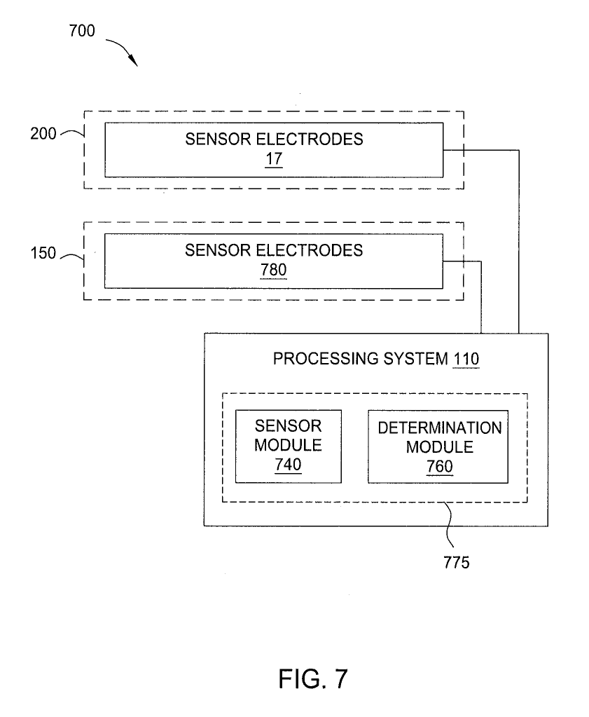

FIG. 6 is a simplified cross-sectional side view of the input device 200 where a force is applied to the control member 22. Some reference characters shown in FIGS. 2-3 are omitted for clarity. In the present example, a force is applied to the control member 22. The force is applied proximate an edge of the control member 22 such that the control member 22 rotates about a pivot 602. The pivot 602 is generated at a contact point between the base 23 of the control member 22 and the plate 26. The spring plate 20 flexes as the control member 22 rotates about the pivot 602. On the side of the control member 22 opposite the pivot 602, a gap 604 forms between the base 23 of the control member 22 and the plate 26. The gap 604 includes a narrow portion 604B and a wide portion 604A. The angle between the base 23 of the control member 22 and the plate 26 increases as more force is applied to the control member 22. As the control member rotates 22 about the pivot 602, the spring plate 20 flexes, modifying the gap 36 between the spring plate 20 and the sensor substrate 16. The gap 36 increases on the side of the pivot 602 and decreases on the side opposite the pivot 602. When the force is removed from the control member 22, the spring plate 20 provides a restoring force to restore the control member 22 to its initial position as shown in FIG. 3. In the initial position, as shown in FIG. 3, the gap 36 between the spring plate 20 and the sensor substrate 16 is uniform.

Returning to FIG. 5, in operation, the spring plate 20 is held at a substantially constant voltage, such as electrical ground. In an example, the processing system 110 drives one or more of the sensor electrodes 17 with a transmitter signal and receives resulting signals from others of the sensor electrodes 17. The processing system 110 can determine measurements of transcapacitance from the resulting signals. The processing system 110 can establish baseline measurements of transcapacitance absent force applied to the control member 22. When a force is applied to the control member 22, at least one of the electrode patterns 504 is disposed nearer the spring plate 20, and at least one of the electrode patterns 504 is disposed farther from the spring plate 20. The transcapacitance measurements derived from those electrode patterns 504 that are disposed nearer and farther from the spring plate 20 change from the baseline. In other examples, the processing system 110 can measure absolute capacitance derived from the electrode patterns 504. The absolute capacitance measurements change from a baseline as electrode pattern(s) 504 are brought nearer and farther from the spring plate 20. In general, a force applied to the control member 22 results in a change in the gap 36 between the sensor substrate 16 and the spring plate 20, which changes a variable capacitance between at least one of the sensor electrodes 17 and the spring plate 20.

For example, a force can be applied to the control member 22 such that the spring plate 20 is brought nearer to the sensor electrode pattern 504-2. Consequently, the sensor electrode pattern 504-4 is farther from the spring plate 20. The processing system 110 detects changes in transcapacitance measurements associated with the sensor electrode patterns 504-2 and 504-4. In this manner, the processing system 110 can determine that the applied force is aligned with the x− quadrant. In another example, a force can be applied to the control member 22 such that the sensor electrode patterns 504-1 and 504-2 are nearer the spring plate 20, and the sensor electrode patterns 504-3 and 504-4 are farther from the spring plate 20. The processing system 110 detects changes in transcapacitance measurements from each of the sensor electrode patterns 504. In this manner, the processing system 110 can determine that the applied force is aligned between the x− and y− quadrants. By detecting force alignment, the processing system 110 can determine motion of a user interface indicator, such as a cursor.

FIG. 7 is a block diagram of an input device 700 according to an example implementation. The input device 700 comprises an example implementation of the input device 100 shown in FIG. 1. The input device 700 includes the pointing stick 180 coupled to the processing system 110. The pointing stick 180 can include the input device 200 described above. Accordingly, the pointing stick 180 includes the sensor electrodes 17. In some embodiments, the processing system 110 is further coupled to a two-dimensional capacitive input device, such as the proximity sensor device 150. The proximity sensor device 150 can include a two-dimensional array of sensor electrodes 780 that can be used for capacitive sensing of input. Thus, the processing system 110 can drive sensor electrodes of the pointing stick 180 or, in some embodiments, sensor electrodes of both the pointing stick 180 and the proximity sensor device 150.

In general, the processing system 110 drives sensor electrodes, receives from sensor electrodes, or both to measure changes in variable capacitance (e.g., transcapacitance or absolute capacitance). The terms “excite” and “drive” as used herein encompasses controlling some electrical aspect of the driven element. For example, it is possible to drive current through a wire, drive charge into a conductor, drive a substantially constant or varying voltage waveform onto an electrode, etc. The processing system 110 can drive a sensor electrode with a transmitter signal. A transmitter signal can be constant, substantially constant, or varying over time, and generally includes a shape, frequency, amplitude, and phase. The processing system 110 can receive a resulting signal from a sensor electrode. The resulting signal can include effects of an input object. The processing system 110 can determine measurements of transcapacitance or absolute capacitance from a resulting signal.

The processing system 110 can include a sensor module 740 and a position determiner module 760. The sensor module 740 and the position determiner module 760 comprise modules that perform different functions of the processing system 110. In other examples, different configurations of modules can perform the functions described herein. The sensor module 740 and the position determiner module 760 can be implemented using sensor circuitry 775 and can also include firmware, software, or a combination thereof operating in cooperation with the sensor circuitry 775.

The sensor module 740 is configured to operate the sensor electrodes 17. As described above, the sensor electrodes 17 are disposed on a substrate 16. The sensor module 740 is configured to drive a sensing signal on a first subset of the sensor electrodes 17 and receive resulting signals from a second subset of the sensor electrodes 17. The resulting signals include effects from a change in baseline capacitance, which changes in response to a change in spacing between the sensor substrate 16 and the spring plate 20 caused by a deflection of the control member 22. While the sensor module 740 is operating the sensor electrodes 17, the sensor module 740 can also operate the sensor electrodes 780.

In an embodiment, the determination module 760 is configured to measure a change in capacitive couplings based on measurements obtained from the sensor electrodes 17. The determination module 760 can control a user interface indicator in response to a change in capacitive coupling. The user interface indicator can comprise, for example, a cursor of an electronic device. The determination module 760 can control motion of the cursor in response to changes in capacitive couplings and/or baseline capacitance.

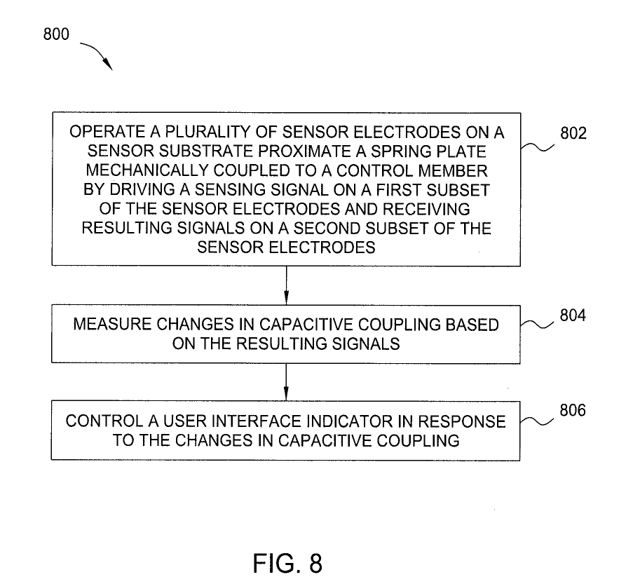

FIG. 8 is a flow diagram depicting a method 800 of operating an input device configured to control a user interface indicator of an electronic device according to an embodiment. The method 800 begins at step 802, where the processing system 110 operates a plurality of sensor electrodes 17 on a sensor substrate 16 proximate a spring plate 20 that is mechanically coupled to a control member 22 by driving a sensing signal on a first subset of the sensor electrodes 17 and receiving resulting signals on a second subset of the sensor electrodes 17. At step 804, the processing system 110 measures changes in capacitive coupling based on the resulting signals. At step 806, the processing system 110 can control a user interface indicator in response to changes in the capacitive coupling.

FIG. 9 is a simplified cross-sectional side view of the input device 200 as mounted to a keyboard in an electronic device. Some reference characters shown in FIGS. 2-3 are omitted for clarity. In the present example, the mounting bracket 14 is secured to a keyboard plate 902 of a keyboard. A gap 904 exists between the keyboard plate 902 and the mounting plate 26 of the input device 200. The sealing member 32 is disposed between the keyboard plate 902 and the mounting plate 26 so as to seal the gap 904. The sealing member 32 can prevent liquid or other contaminants from entering into the gap 904 and into the input device 200.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. An isometric input device configured to control a user interface indicator of an electronic device, the input device comprising:
a plurality of sensor electrodes disposed on a sensor substrate;
a spring plate disposed between top and bottom spacers, the bottom spacer contacting the sensor substrate and defining a gap between the sensor electrodes and the spring plate;
a control member mechanically coupled to the spring plate;
a mounting plate in contact with the top spacer;
a mounting bracket having an assembly of the mounting plate, the spring plate, the top and bottom spacers, and the sensor substrate mounted thereto.

2. The input device of claim 1, wherein the sensor substrate is communicatively coupled to a processing system, the processing system configured to operate the plurality of sensor electrodes.

3. The input device of claim 2, wherein the processing system is further configured to operate a capacitive touchpad of the electronic device.

4. The input device of claim 1, wherein the spring plate is configured to be ohmically coupled to a substantially constant electrical potential.

5. The input device of claim 1, wherein a force applied to the control member results in a change in the gap between the sensor electrodes and the spring plate, changing a variable capacitance between at least one of the sensor electrodes and the spring plate.

6. The input device of claim 1, wherein the spring plate is configured to provide a biasing force in response to a force applied to the control member and a restoring force in response to removal of the force applied to the control member.

7. The input device of claim 1, wherein the control member is riveted to the spring plate.

8. The input device of claim 1, further comprising a dielectric element disposed around a post of the control member.

9. The input device of claim 8, further comprising a sealing ring disposed between the dielectric element and the mounting plate.

10. A processing system for an input device configured to control a user interface indicator of an electronic device, the processing system comprising:
a sensor module including sensor circuitry, the sensor module configured to operate a plurality of sensor electrodes on a sensor substrate disposed proximate to a spring plate, which is mechanically coupled to a control member, by driving a sensing signal on a first subset of the plurality of electrodes and receiving resulting signals from a second subset of the plurality of electrodes, the resulting signals including effects from a change in spacing between the sensor substrate and the spring plate caused by a deflection of the spring plate; and
a determination module configured to measure a change in capacitive coupling based on the resulting signals.

11. The processing system of claim 10, wherein the determination module is configured to control the user interface indicator in response to the change in capacitive coupling.

12. The processing system of claim 11, wherein the user interface indicator comprises a cursor and wherein the determination module is configured to control motion of the cursor in response to the change in capacitive coupling.

13. The processing system of claim 10, wherein the sensor module is configured to operate a capacitive touchpad of the electronic device.

14. The processing system of claim 10, wherein the spring plate is configured to be coupled to a substantially constant electrical potential.

15. A method of operating an input device configured to control a user interface indicator of an electronic device, the method comprising:
operating a plurality of sensor electrodes on a sensor substrate disposed proximate to a spring plate, which is mechanically coupled to a control member, by driving a sensing signal on a first subset of the plurality of electrodes and receiving resulting signals from a second subset of the plurality of electrodes, the resulting signals including effects from a change in spacing between the sensor substrate and the spring plate caused by a deflection of the spring plate; and
measuring a change in capacitive coupling based on the resulting signals.

16. The method of claim 15, further comprising:
controlling the user interface indicator in response to the change in capacitive coupling.

17. The method of claim 16, wherein the user interface indicator comprises a cursor and wherein motion of the cursor is controlled in response to the change in capacitive coupling.

18. The method of claim 15, further comprising operating a capacitive touchpad of the electronic device concurrently with the plurality of sensor electrodes.

19. The method of claim 15, further comprising coupling the spring plate to a substantially constant electrical potential.

20. The method of claim 15, wherein the spring plate is separated from the sensor substrate by a spacer.
